(19) United States
(12) Patent Application Publication
(10) Pub. No.: US 2026/0161245 A1
(43) Pub. Date: Jun. 11, 2026

(54) DISPLAY DEVICE AND ELECTRONIC DEVICE INCLUDING THE SAME

(71) Applicant: Samsung Display Co., Ltd., Yongin-Si (KR)

(72) Inventors: JIYEONG LEE, Yongin-si (KR); MIN-HONG KIM, Yongin-si (KR); BOGEUN YUK, Yongin-si (KR)

(21) Appl. No.: 19/319,737

(22) Filed: Sep. 5, 2025

(30) Foreign Application Priority Data
Dec. 9, 2024 (KR) 10-2024-0181437

(51) Int. Cl. G06F 3/041; G06F 3/044; G09G 3/00; G09G 3/20

(52) U.S. Cl. CPC G06F 3/0416; G06F 3/0446; G09G 3/035; G09G 3/2092; G06F 2203/04102; G06F 2203/04108; G09G 2354/00

(57) ABSTRACT

A display device includes a display panel including a pixel circuit, and a display panel driver configured to drive the display panel. The display panel includes a sensing region, and a display region surrounding the sensing region. The sensing region includes a hole region including a hole which extend through the display panel and configured to transmit light, and a distance signal sensing region surrounding the hole region and including a distance signal sensing electrode. A proximity sensor configured to detect proximity of an object based on a capacitance variation is located in the sensing region.

### CROSS-REFERENCE TO RELATED APPLICATION(S)

This application claims priority under 35 USC § 119 to Korean Patent Application No. 10-2024-0181437, filed on Dec. 9, 2024 in the Korean Intellectual Property Office, the content of which is herein incorporated by reference in its entirety.

### BACKGROUND

### 1. Field

Embodiments of the present inventive concept relate to a display device and an electronic device. More particularly, embodiments of the present inventive concept relate to a display device an electronic device performing a touch operation.

### 2. Description of the Related Art

A display apparatus may include a display panel and a display panel driver. The display panel includes a plurality of gate lines, a plurality of data lines, a plurality of emission lines and a plurality of pixels. The display panel driver includes a gate driver providing a gate signal to the gate lines, a data driver providing a data voltage to the data lines, an emission driver providing an emission signal to the emission lines and a driving controller controlling the gate driver, the data driver and the emission driver.

In order to reduce power consumption, a display device that supports a call mode upon receiving a call has been recently developed. In such a call mode, in order for the display device to determine whether to turn the display panel on or off, it is necessary to accurately measure a distance to an object. Since a touch panel of a conventional display device has a limitation in measuring a capacitance variation, it is difficult to enter the call mode at a predetermined distance or more.

### SUMMARY

Embodiments of the present inventive concept provide a display device capable of driving a touch panel to be operated suitably in a call mode.

Embodiments of the present inventive concept also provide an electronic device capable of driving a touch panel to be operated suitably in a call mode.

According to embodiments, a display device includes a display panel including a pixel circuit, and a display panel driver configured to drive the display panel. The display panel includes a sensing region, and a display region surrounding the sensing region. The sensing region includes a hole region including a hole which extends through the display panel and configured to transmit light, and a distance signal sensing region surrounding the hole region and including a distance signal sensing electrode. A proximity sensor configured to detect proximity of an object based on a capacitance variation is located in the sensing region.

In an embodiment, the display panel may be configured to stop displaying an image when the proximity sensor detects that a distance between the object and the display panel is equal to or less than a second reference distance.

In an embodiment, wherein the display panel may further include a touch sensor configured to detect a touch. The display panel driver may output a touch signal to the touch sensor. The display panel driver may stop outputting the touch signal when the proximity sensor detects that the distance between the object and the display panel is equal to or less than the second reference distance.

In an embodiment, the display panel driver may output a distance signal to the proximity sensor. The distance signal may toggle between a first voltage and a second voltage lower than the first voltage. The touch signal may toggle between a third voltage and a fourth voltage lower than the third voltage. The first voltage may be higher than the third voltage.

In an embodiment, the distance signal may have a first frequency, and the touch signal may have a second frequency. The first frequency may be lower than the second frequency.

In an embodiment, the display panel driver may output a distance signal to the proximity sensor. The distance signal may have a first frequency, and the touch signal may have a second frequency. The first frequency may be different from the second frequency.

In an embodiment, the first frequency may be lower than the second frequency.

In an embodiment, the display panel driver may include a gate driver configured to output a gate signal to the pixel circuit, a data driver configured to apply a data voltage to the pixel circuit, a touch driver configured to perform a touch sensing operation, and a driving controller configured to control the gate driver, the data driver and the touch driver based on an input control signal. The display panel may further include a touch sensor configured to detect a touch. The touch driver may output a distance signal to the proximity sensor, and a touch signal different from the distance signal to the touch sensor.

In an embodiment, the touch driver may include a distance signal sensing block configured to output the distance signal, and a touch signal sensing block configured to output the touch signal. The touch signal sensing block may stop outputting the touch signal when the proximity sensor detects that a distance between the object and the display panel is equal to or less than the second reference distance.

In an embodiment, the touch driver may operate the display panel in a self-capacitance method.

In an embodiment, the touch driver may operate the display panel in a mutual capacitance sensing method.

In an embodiment, the display panel may include a foldable region, a first non-folding region adjacent to the foldable region and a second non-folding region adjacent to the foldable region. The first non-folding region may include the sensing region. When the capacitance variation may be equal to less than a reference capacitance variation, the display panel may display an image.

In an embodiment, the capacitance variation may be determined based on an angle between the first non-folding region and the second non-folding region.

In an embodiment, when the capacitance variation is greater than the reference capacitance variation, the display panel may stop displaying the image.

According to embodiments, an electronic device includes a display panel including a pixel circuit, a display panel driver configured to drive the display panel based on input control signal, and a processor configured to output the input control signal. The display panel includes a sensing region, and a display region surrounding the sensing region. The sensing region includes a hole region including a hole which extends through the display panel and configured to transmit light, and a distance signal sensing region surrounding the hole region and including a distance signal sensing electrode. A proximity sensor configured to detect proximity of an object based on a capacitance variation is located in the sensing region.

In an embodiment, the display panel may be configured to stop displaying an image when the proximity sensor detects that a distance between the object and the display panel is equal to or less than a second reference distance.

In an embodiment, the display panel may further include a touch sensor configured to detect a touch. The display panel driver may output a touch signal to the touch sensor. The display panel driver may stop outputting the touch signal when the proximity sensor detects that the distance between the object and the display panel is equal to or less than the second reference distance.

In an embodiment, the display panel driver may output a distance signal to the proximity sensor. The distance signal may toggle between a first voltage and a second voltage lower than the first voltage. The touch signal may toggle between a third voltage and a fourth voltage lower than the third voltage. The first voltage may be higher than the third voltage.

In an embodiment, the distance signal may have a first frequency, and the touch signal may have a second frequency. The first frequency may be different from the second frequency.

The first frequency may be lower than the second frequency.

As described above, the display panel of the display device may include the proximity sensor. The proximity sensor may be located in a sensing region including a hole region. The proximity sensor may be located in a sensing region, so that the touch electrodes may not perform the proximity operation. Accordingly, an accuracy of a touch operation may be improved compared to the touch electrodes performing the proximity operation.

Additionally, the proximity sensor may be placed in the sensing region, so that the proximity sensor and electrodes for the touch sensing operation may not overlap. The proximity sensor and the electrodes for the touch sensing operation may not overlap, so that the reliability of the touch sensing operation may be improved.

Additionally, a voltage range of the distance signal and a voltage range of the touch signal may be different. Additionally, a frequency of the distance signal and a frequency of the touch signal may be different. Accordingly, a power consumption of the display device may be effectively controlled.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to an embodiment of the present inventive concept.

FIG. 2 is a diagram illustrating a display panel included in a display device of FIG. 1.

FIG. 3 is a block diagram illustrating a touch driver included in a display device of FIG. 1.

FIG. 4 is a block diagram illustrating a distance signal sensing block included in a touch driver of FIG. 3

FIG. 5 is a diagram illustrating a sensing region included in a display panel of FIG. 2.

FIG. 6 is a block diagram illustrating a display panel of FIG. 1 and a touch signal sensing block of FIG. 3.

FIG. 7 is a timing diagram illustrating a distance signal and a touch signal outputted from a touch driver included in a display device of FIG. 1.

FIG. 8 is a diagram illustrating an example in which a display device of FIG. 1 is used.

FIG. 9 is a diagram illustrating an operation of a display panel when a display device of FIG. 1 operates in a first mode.

FIG. 10 is a diagram illustrating an operation of a display panel when a display device of FIG. 1 operates in a second mode.

FIG. 11 is a timing diagram illustrating signals outputted from a touch driver of FIG. 1 when a display device of FIG. 1 operates in a second mode.

FIG. 12 is a diagram illustrating a sensing region included in a display panel of FIG. 2.

FIG. 13 is a block diagram illustrating a display panel of FIG. 1 and a touch signal sensing block of FIG. 3.

FIG. 14 is a diagram illustrating a display device of FIG. 1.

FIG. 15 is a diagram illustrating a display device of FIG. 1.

FIG. 16 is a block diagram illustrating an electronic device according to an embodiment of the present inventive concept.

FIG. 17 is a diagram illustrating an example in which the electronic device of FIG. 16 is implemented as a smartphone.

### DETAILED DESCRIPTION OF THE INVENTIVE CONCEPT

Hereinafter, the present inventive concept will be explained in detail with reference to the accompanying drawings.

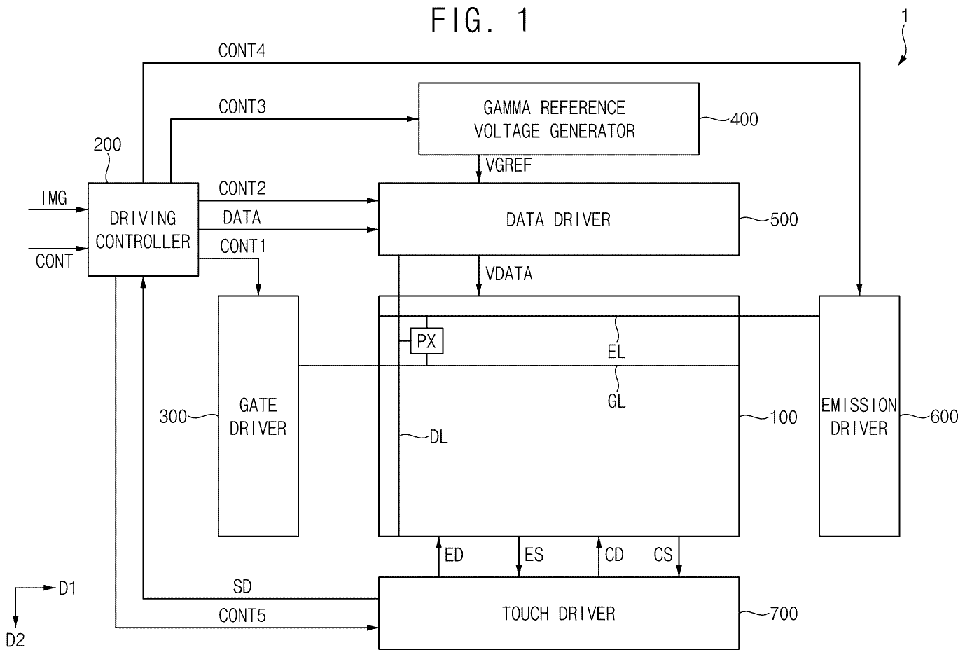

FIG. 1 is a block diagram illustrating a display device 1 according to an embodiment of the present inventive concept.

Referring to FIG. 1, the display device 1 may include a display panel 100 and a display panel driver. The display panel driver may include a driving controller 200, a gate driver 300, a gamma reference voltage generator 400, a data driver 500, an emission driver 600 and a touch driver 700.

The display panel 100 may have a display region on which an image is displayed and a peripheral region adjacent to the display region.

The display panel 100 may include a plurality of gate lines GL, a plurality of data lines DL, a plurality of emission lines EL and a plurality of pixel circuit PX electrically connected to the gate lines GL, the emission lines EL and the data lines DL. The gate lines GL may extend in a first direction D1. The data lines DL may extend in a second direction D2 crossing the first direction D1. The emission lines EL may extend in the first direction D1.

In an embodiment, the pixel circuit PX may include a plurality of transistors, a storage capacitor and a light emitting element. At least one of the plurality of transistors may apply the data voltage VDATA to the storage capacitor in response to a gate signal. At least one of the plurality of transistors may generate a driving current based on the data voltage VDATA stored in the storage capacitor. At least one of the plurality of transistors may form a current path form a first power voltage to a second power voltage in response to an emission signal. The storage capacitor may store the data voltage applied to the pixel circuit PX. The light emitting element may emit light based on the driving current. In an embodiment, the pixel circuit PX may have a structure including at least two transistors and one capacitor.

The driving controller 200 may receive input image data IMG and an input control signal CONT from an external device (e.g., a processor illustrated in FIG. 16). For example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, a fifth control signal CONT5 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller may generate the fourth control signal CONT4 for controlling an operation of the emission driver 600 based on the input control signal CONT, and output the fourth control signal CONT4 to the emission driver 600.

The driving controller may generate the fifth control signal CONT5 for controlling an operation of the touch driver 700 based on the input control signal CONT, and output the fifth control signal CONT5 to the touch driver 700.

The gate driver 300 may generate gate signals, which is transmitted to the gate lines GL, in response to the first control signal CONT1 received from the driving controller 200. The gate driver 300 may output the gate signals to the gate lines GL.

In an embodiment, the gate driver 300 may be disposed in the peripheral region. In an embodiment, the gate driver 300 may be integrated in the peripheral region.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA.

In an embodiment, the gamma reference voltage generator 400 may be disposed in the driving controller 200, or in the data driver 500.

The data driver 500 may receive the second control signal CONT2 and the data signal DATA from the driving controller 200, and receive the gamma reference voltages VGREF from the gamma reference voltage generator 400. The data driver 500 may convert the data signal DATA into data voltages having an analog type using the gamma reference voltages VGREF. The data driver 500 may output the data voltages VDATA to the data lines DL.

In an embodiment, the data driver 500 may be disposed in the peripheral region. In an embodiment, the data driver 500 may be integrated in the peripheral region.

The emission driver 600 may generate emission signal in response to the fourth control signal CONT4 received from the driving controller 200. The emission driver 600 may output the emission signal to the display panel 100.

In an embodiment, the emission driver 600 may be disposed in the peripheral region. In an embodiment, the emission driver 600 may be integrated in the peripheral region.

Although the gate driver 300 is disposed on a first side of the display panel 100, and the emission driver 600 is disposed on a second side of the display panel 100 in FIG. 1 for convenience of explanation, the present inventive concept is not limited thereto. The gate driver 300 and the emission driver 600 may be disposed on the first side of the display panel 100. For example, the gate driver 300 and the emission driver 600 may be disposed on both sides of the display panel 100. For example, the gate driver 300 and the emission driver 600 may be formed integrally with each other.

The display panel 100 may be a capacitance-type touch panel configured to sense a capacitance variation caused by a touch of a conductive object (e.g., a finger, a stylus pen, etc.). For example, the display panel 100 may include a plurality of first electrodes extending in a first direction D1 and a plurality of second electrodes extending in a second direction D2 that is orthogonal to the first direction.

In an embodiment, a layer on which the first electrodes are formed and a layer on which the second electrodes are formed may be different from each other. In this case, each of the first electrodes and the second electrodes may have a straight-line shape. However, the present inventive concept is not limited thereto. For example, the first electrodes and the second electrodes may be formed on substantially the same layer. In this case, each of the first electrodes and the second electrodes may have a structure in which a plurality of polygons, which are consecutively arranged and having diamond shapes, respectively, are connected to each other. However, the shape and connection arrangement of the first electrodes and the second electrodes are not limited thereto.

In an embodiment, the display panel 100 may be an add-on type touch panel which is attached onto panel including the pixel circuit PX, or an embedded-type touch panel which is formed continuously on the panel including the pixel circuit PX. For example, the display panel 100 may be an on-cell type embedded touch panel or an in-cell type embedded touch panel, but the type of the touch panel is not limited thereto.

The touch driver 700 may generate a touch signal ED and a distance signal CD in response to the fifth control signal CONT5 received from the driving controller 200. The touch driver 700 may receive a touch sensing signal ES based on the touch signal ED. The touch driver 700 may receive the distance sensing signal CS based on the distance signal CS. The touch driver 700 may output sensing data SD based on the touch sensing signal ES and the distance sensing signal CS to the driving controller 200.

The touch driver 700 may drive the display panel 100 to detect a touch and/or proximity of a conductive object. The touch driver 700 may drive the display panel 100 in a mutual capacitance sensing method or a self-capacitance sensing method. For example, the touch driver 700 may perform a touch sensing operation in the mutual capacitance sensing method by sensing variations in mutual capacitances between the first electrodes and the second electrodes. For example, the touch driver 700 may perform a touch sensing operation in the self capacitance sensing method by sensing variations in self capacitances of the second electrodes (or capacitances between the second electrodes and the conductive object), or may perform the touch sensing operation in the self capacitance sensing method by sensing variations in self capacitances of the first electrodes (or capacitances between the first electrodes and the conductive object).

In an embodiment, the touch driver 700 may drive the display panel 100 in the self-capacitance sensing method to detect the approach of the conductive object to the display panel 100. When the conductive object approaches the display device 1 within a predetermined distance or less, the mode of the display device 1 may be switched from the normal mode to the call mode. For example, the display panel 100 driven in the mutual capacitance sensing method may detect the touch of the conductive object only when the conductive object touches the display panel 100, while the display panel 100 driven in the self-capacitance sensing method may detect the proximity of the conductive object to the display panel 100 even before the conductive object touches the display panel 100.

The display device 1 may support a call mode where an image is not displayed on the display panel 100 as well as a normal mode where an image is displayed on the display panel 100. In this case, the call mode of the display device 1 may refer to a mode in which an image is not displayed on the display panel 100. In detail, the display device 1 may be driven in the normal mode when the display device 1 is powered on, and a driving mode of the display device 1 may be switched from the normal mode to the call mode when a predetermined condition is satisfied.

In an embodiment, a mode of the display device 1 may be switched from the normal mode to the call mode when a capacitance of an internal electrode of the display panel 100 changes. For example, when a conductive object approaches within a predetermined distance or less, the display device 1 may activate a proximity function. When the display device 1 activates the proximity function, the display device 1 may measure a distance to the conductive object based on a variation in capacitance of the internal electrode included in the display device 1. In this case, when the conductive object approaches the display device 1 within the predetermined distance or less, the display device 1 may switch to the call mode. When the display device 1 enters the call mode, the display panel 100 may stop displaying the image.

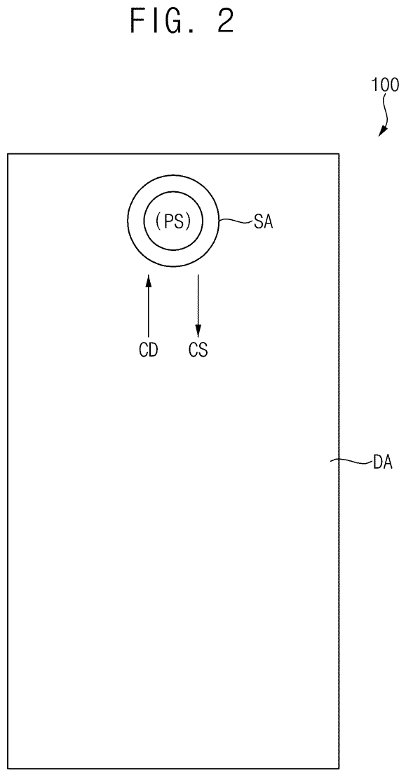

FIG. 2 is a diagram illustrating a display panel 100 included in a display device 1 of FIG. 1.

Referring to FIG. 1 and FIG. 2, the display panel 100 may include a display region DA and a sensing region SA.

The pixel circuit PX may be arranged on the display region DA. The display region DA may surround the sensing region SA.

Light may pass through the sensing region SA. For example, a hole having a cylindrical structure penetrating the display device 1 or the display panel 100 may be formed in the sensing region SA. In an embodiment, a cover window including a material which transmits light may be located on the sending region SA. For example, the sending region SA may include a hole region and a peripheral region.

The sensing region may be non-displaying region where the light emitting element is not located. For example, the pixel circuit PX may not be arranged on the sensing region SA.

In an embodiment, the display device 1 may include an optical module. The optical module may be located to overlap with the sensing region SA. For example, the optical module may include a camera module capable of capturing an image of an object, a face recognition sensor module capable of detecting a user's face, a pupil recognition sensor module capable of detecting the user's pupils, an acceleration sensor module capable of detecting movement of the display device 1, a proximity sensor module capable of detecting whether an object is close, etc.

In an embodiment, the proximity sensor PS may be located on the sensing region SA. The proximity sensor PX may output the distance sensing signal CS based on the distance signal CD.

The proximity sensor PS may detect the proximity of the conductive object based on a variation in capacitance of an internal electrode of the proximity sensor PS. In an embodiment, the touch driver 700 may activate the proximity function when the conductive object approaches within a predetermined distance or less. When the proximity function is activated, the proximity sensor PS may measure a distance to the conductive object based on the variation in capacitance of the internal electrode included in the proximity sensor PS. When the conductive object approaches the proximity sensor PS within the predetermined distance or less, the display device 1 may be switched to the call mode. The proximity sensor PS may be spaced apart from the electrodes included in the display panel 100.

In an embodiment, the proximity sensor PS may be located on a sensing region SA where an image is not displayed on the display panel 100. Accordingly, the display device 1 may include the proximity sensor PS without reducing the display area DA of the display panel 100. Additionally, the proximity sensor PS may be placed in the sensing region SA instead of a conventional dummy metal. Accordingly, the proximity sensor PS and electrodes for the touch sensing operation may not overlap. As the proximity sensor PS and the electrodes for the touch sensing operation may not overlap, the reliability of the touch sensing operation may be improved.

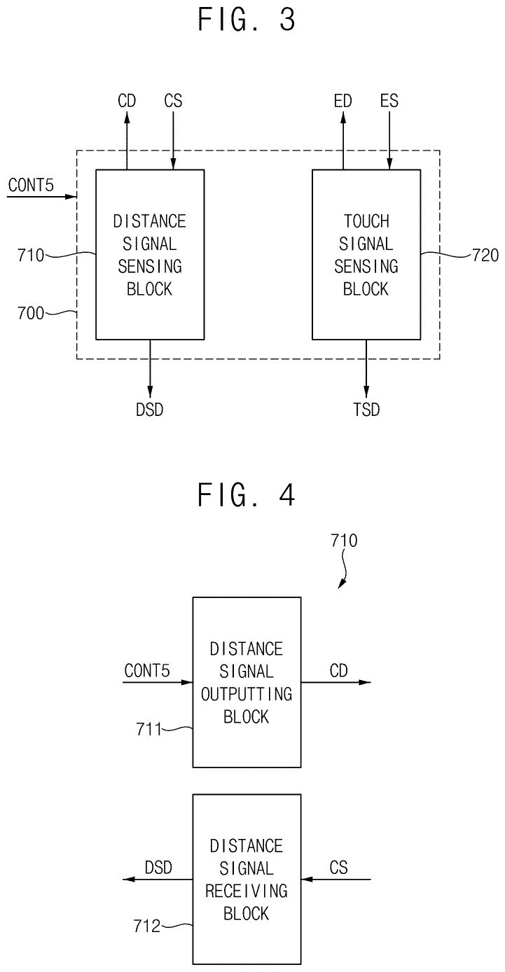

FIG. 3 is a block diagram illustrating a touch driver 700 included in a display device 1 of FIG. 1. FIG. 4 is a block diagram illustrating a distance signal sensing block 710 included in a touch driver 700 of FIG. 3

Referring to FIG. 1 to FIG. 4, the touch driver 700 may include a distance signal sensing block 710 and a touch signal sensing block 720. The touch driver 700 may output distance sensing data DSD and touch sensing data TSD based on the fifth control signal CONT5.

The distance signal sensing block 710 may perform the proximity operation based on the proximity sensor PS. The distance signal sensing block 710 may include a distance signal outputting block 711 and a distance signal receiving block 712.

The distance signal outputting block 711 may receive the fifth control signal CONT5 and output the distance signal CD based on the fifth control signal CONT5. The distance signal outputting block 711 may output the distance signal CD to the proximity sensor PS. The distance signal receiving block 712 may receive the distance sensing signal CS that is generated based on the distance signal CD in the proximity sensor PS. The distance signal receiving block 712 may receive the distance sensing signal CS from the proximity sensor PS. The distance signal receiving block 712 may output the distance sensing data DSD based on the distance sensing signal CS. For example, the distance signal receiving block 712 may output the distance sensing data DSD to the driving controller 200.

The touch signal sensing block 720 may perform the touch sensing operation based on touch electrodes. The touch signal sensing block 720 may output the touch signal ED to the touch electrodes. The touch signal sensing block 720 may receive the touch sensing signal ES which is generated based on the touch signal ES in the touch electrodes. The touch signal sensing block 720 may receive the touch sensing signal ES from the touch electrodes. The touch signal sensing block 720 may output the touch sensing data TSD based on the touch sensing signal ES. For example, the touch signal sensing block 720 may output the touch sensing data TSD to the driving controller 200.

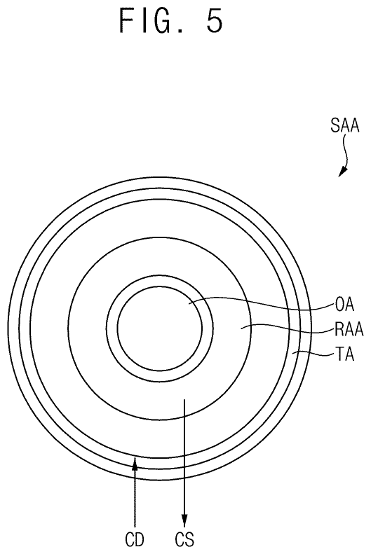

FIG. 5 is a diagram illustrating a sensing region SA included in a display panel 100 of FIG. 2.

Referring to FIG. 1 to FIG. 5, a sensing region SAA may include a hole region OA, a distance signal sensing region RAA and a distance signal outputting region TA. The hole region OA may penetrate the display device 1 or the display panel 100. For example, the hole region OA may have a cylinder structure. The distance signal sensing region RAA may surround the hole region OA. The distance signal sensing region RAA may be located adjacent to the hole region OA. A distance signal sensing electrode may be located in the distance sensing signal region RAA. The distance signal outputting region TA may surround the distance signal sensing region RAA. The distance signal outputting region TA may be located adjacent to the distance signal sensing region RAA. A distance signal outputting electrode may be located in the distance signal outputting region TA. The distance signal outputting region TA may be located adjacent to the pixel circuit PX.

The distance signal sensing block 710 may apply the distance signal CD to the distance signal outputting electrode. For example, the distance signal CD may be one or more consecutive voltage pulses. However, the distance signal CD according to the present inventive concept is not limited to the one or more consecutive voltage pulses as explained above. For example, the distance signal CD may have various forms such as a sine wave and a triangular wave. The distance signal outputting electrode may be coupled with the distance signal sensing electrode. The distance signal outputting electrode may be coupled with the distance signal sensing electrode and apply the distance signal CD to the distance signal sensing electrode. When the conductive object is adjacent to the distance signal sensing electrode or makes contact with the distance signal sensing electrode, a capacitance of distance signal sensing electrode may be changed. The distance signal sensing electrode may output the distance sensing signal CS to the distance signal sensing block 710. The distance sensing signal CS may refer to a variation in capacitance of the distance signal sensing electrode.

In an embodiment, the proximity sensor PS may detect the proximity of the conductive object based on a variation in a capacitance of the distance signal sensing electrode. The touch driver 700 may activate the proximity function when the conductive object approaches the distance signal sensing electrode within a predetermined distance or less. When the proximity function is activated, the proximity sensor PS may measure a distance to the conductive object based on the variation in capacitance of the distance signal sensing electrode. When the conductive object approaches the proximity sensor PS within the predetermined distance or less, the display device 1 may be switched to the call mode.

In an embodiment, the distance signal sensing electrode may have a donut shape. However, the present inventive concept is not limited to the shape of the distance signal sensing electrode explained above. For example, the distance signal sensing electrode may have a line shape.

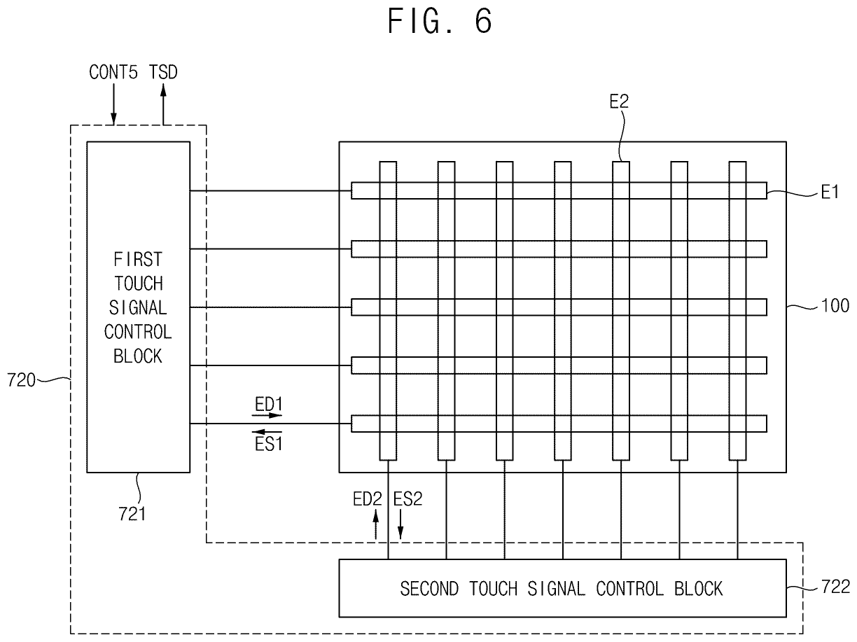

FIG. 6 is a block diagram illustrating a display panel 100 of FIG. 1 and a touch signal sensing block 720 of FIG. 3.

Referring to FIG. 1 to FIG. 6, the touch signal sensing block 720 in the touch driver 700 may be connected to the display panel 100 through a plurality of first touch electrodes E1 and a plurality of second touch electrodes E2. The display panel 100 may include the plurality of first touch electrodes E1 extending in a first direction D1, and the plurality of second touch electrodes E2 extending in a second direction D2 that is orthogonal to the first direction D1. The first touch electrodes E1 included in the display panel 100 may be disposed on a different layer than the second touch electrodes E2 included in the display panel 100. Each of the first touch electrodes E1 and the second touch electrodes E2 may have a straight-line shape.

In an embodiment, the touch signal sensing block 720 may include a first touch signal control block 721 connected to the first touch electrodes E1 and a second touch signal control block 722 connected to the second touch electrodes E2 so as to provide both the mutual capacitance sensing method and the self capacitance sensing method.

The first touch signal control block 721 may sequentially apply first touch signals ED1 to the first touch electrodes E1. For example, the first touch signal control block 721 may sequentially apply the first touch signals ED1 to the first touch electrodes E1 through a plurality of first lines which connect the first touch signal control block 721 to the first touch electrodes E1. For example, each of the first touch signals ED1 may be one or more consecutive voltage pulses, but is not limited thereto. For example, each of the first touch signals ED1 may have various forms such as a sine wave and a triangular wave. When the conductive object approaches the first touch electrodes E1 or makes contact with the first touch electrodes E1, a capacitance of each of the first touch electrodes E1 may be changed. The first touch control block 721 may sense the first touch sensing signals ES1 based on the variation in capacitance of the first touch electrodes E1. The first touch control block 721 may receive the first touch sensing signals ES1 through the first lines. The first touch sensing signals ES1 may include capacitance variation values of the first touch electrodes E1, respectively.

The second touch signal control block 722 may sequentially apply second touch signals ED2 to the second touch electrodes E2. For example, the second touch signal control block 722 may sequentially apply the second touch signals ED2 to the second touch electrodes E2 through a plurality of second lines which connect the second touch signal control block 722 to the second touch electrodes E2. For example, each of the second touch signals ED2 may be one or more consecutive voltage pulses, but is not limited thereto. For example, each of the second touch signals ED2 may have various forms such as a sine wave and a triangular wave. When the conductive object approaches the second touch electrodes E2 or makes contact with the second touch electrodes E2, a capacitance of each of the second touch electrodes E2 may be changed. The second touch control block 722 may sense the second touch sensing signals ES2 based on the variation in the capacitance of the second touch electrodes E2. The second touch control block 722 may receive the second touch sensing signals ES2 through the second lines. The second touch sensing signals ES2 may include capacitance variation values of the second touch electrodes E2, respectively.

The touch signal sensing block 720 in the touch driver 700 may generate touch sensing data TSD based on the first touch sensing signals ES1 and the second touch sensing signals ES2. The touch signal sensing block 720 may generate the touch sensing data TSD that indicates a touch location of the conductive object by sensing a capacitance variation induced by capacitive coupling between the first touch electrodes E1 and the second touch electrodes E2 based on the first touch sensing signals ES1 and the second touch sensing signals ES2. The touch signal sensing block 720 may provide the touch sensing data TSD to the driving controller 200. For example, when the conductive object touches the display panel 100, a mutual capacitance between the first touch electrode E1 and the second touch electrode E2 corresponding to the touch location may be changed (e.g., reduced). The touch driver 700 may sense a location where the mutual capacitance is reduced, that is, the touch location, by merging the capacitance variation values of the first touch electrodes E1 and the second touch electrodes E2 included in the first touch sensing signals ES1 and the second touch sensing signals ES2, respectively, and detecting a reduced capacitance between the first touch electrode E1 and the second touch electrode E2b based on the merged the capacitance variation values.

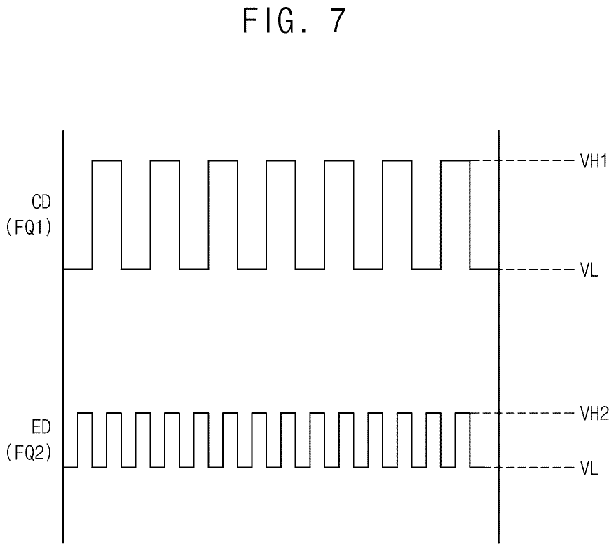

FIG. 7 is a timing diagram illustrating a distance signal CD and a touch signal ED outputted from a touch driver 700 included in a display device 1 of FIG. 1.

Referring to FIG. 1 to FIG. 7, the distance signal CD may toggle between a first high voltage VH1 and a low voltage VL. The first high voltage VH1 may be higher than the low voltage VL. The distance signal CD may have a first frequency FQ1. The distance signal CD may toggle between the first high voltage VH1 and the low voltage VL with the first frequency FQ1.

The touch signal ED may toggle between a second high voltage VH2 and the low voltage VL. The second high voltage VH2 may be higher than the low voltage VL. The touch signal ED may have a second frequency FQ2. The touch signal ED may toggle between the second high voltage VH2 and the low voltage VL with the second frequency FQ2.

The first high voltage VH1 may be higher than the second high voltage VH2. The first frequency FQ1 may be lower than the second frequency FQ2.

The first high voltage VH1 may be higher than the second high voltage VH2, so that a sensing accuracy of the distance sensing signal CS may be improved. Additionally, the first high voltage VH1 may be higher than the second high voltage VH2, so that an accuracy of proximity operation of the proximity sensor PS may be improved. Additionally, compared to touch electrodes performing the proximity operation, a power consumption of the display device 1 may be reduced.

In an embodiment, the proximity sensor PS may be located on a sensing region SAA. The proximity sensor PS may be located on a sensing region SAA, so that the touch electrodes may not perform the proximity operation. Accordingly, an accuracy of a touch operation may be improved compared to the touch electrodes performing the proximity operation.

Additionally, the proximity sensor PS may be placed in the sensing region SAA, so that the proximity sensor PS and electrodes for the touch sensing operation may not overlap. The proximity sensor PS and the electrodes for the touch sensing operation may not overlap, so that the reliability of the touch sensing operation may be improved.

Additionally, a voltage range of the distance signal CD and a voltage range of the touch signal ED may be different. Additionally, a frequency of the distance signal CD and a frequency of the touch signal ED may be different. Accordingly, a power consumption of the display device 1 may be effectively controlled.

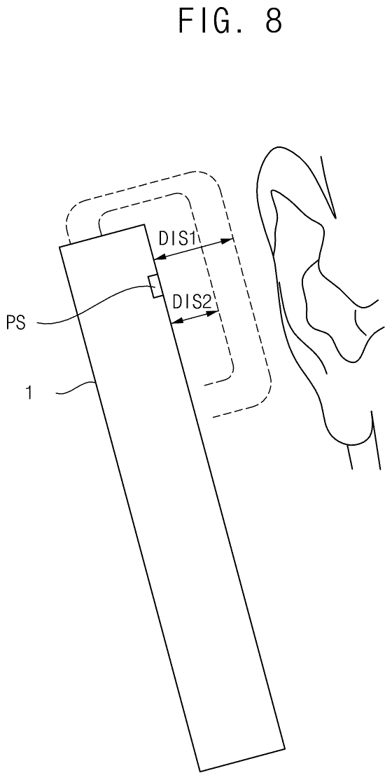

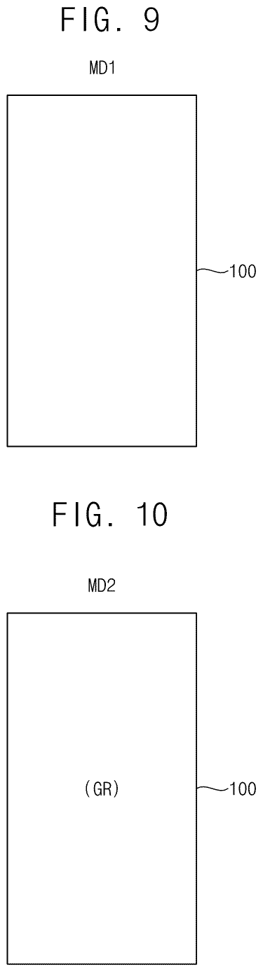

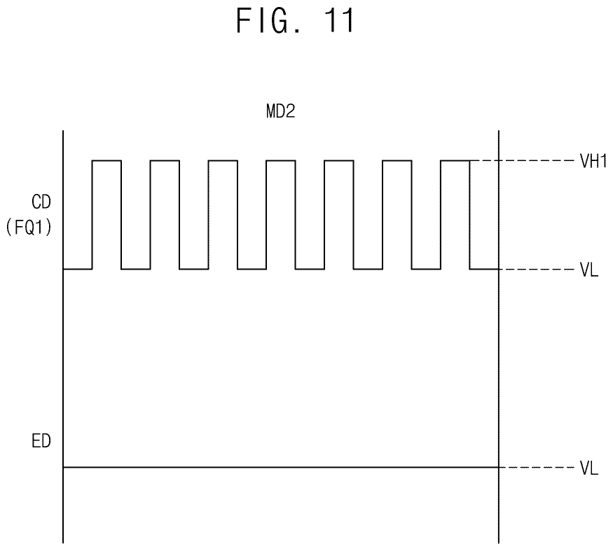

FIG. 8 is a diagram illustrating an example in which a display device 1 of FIG. 1 is used. FIG. 9 is a diagram illustrating an operation of a display panel 100 when a display device 1 of FIG. 1 operates in a first mode MD1. FIG. 10 is a diagram illustrating an operation of a display panel 100 when a display device 1 of FIG. 1 operates in a second mode MD2. FIG. 11 is a timing diagram illustrating signals outputted from a touch driver 700 of FIG. 1 when a display device 1 of FIG. 1 operates in a second mode MD2.

Referring to FIG. 1 to FIG. 11, when conductive object is located at a first reference distance DIS1 from the display device 1, the display device 1 operates in a first mode MD1. When the conductive object is located at a second reference distance DIS2 closer than the first reference distance DIS1, the display device 1 operates in a second mode MD2. The first mode MD1 may be called as a normal mode. The second mode MD2 may be called as a call mode.

The display device 1 may stop displaying the image when the proximity sensor PS detects that the conductive object approaches within a second reference distance DIS2 or less. That is, when the proximity sensor PS detects that a distance between the conductive object and the display panel 100 is equal to or less than the second reference distance DIS2, the display panel 100 stops displaying the image. The second reference distance DIS2 may be a distance at which the display device 1 may activate the proximity function. In detail, when the distance to the conductive object is less than the second reference distance DIS2, the display device 1 may run the proximity function. When the proximity function is activated, the touch driver 700 may determine the proximity of the conductive object through the proximity sensor PS. When the proximity function is operated, the touch driver 700 may determine whether to activate the call mode.

The display device 1 may activate the call mode when the distance to the conductive object is less than a second reference distance DIS2. The second reference distance DIS2 may be an optimum distance between a user and the display device 1 when the user makes a call by using the display device 1. When the display device 1 is operated in the call mode, the display panel 100 may stop displaying an image, unlike the normal mode in which the image is displayed. When the display device 1 is operated in the call mode, the display panel 100 may emit light with a reference grayscale GR. For example, When the display device 1 is operated in the call mode, the full display panel 100 may emit light with the reference grayscale GR. For example, the reference grayscale GR may be about 0 grayscale level.

When the proximity sensor PS detects that the conductive object approaches within the second reference distance DIS2 or less, the touch driver 700 may provide the distance sensing data DSD to the driving controller 200. In this case, the display device 1 may activate the call mode. When the display device 1 is operated in the call mode, the display panel 100 may stop displaying the image. When the user makes a call by using the display device 1, the display panel 100 may stop displaying the image, so that power consumption of the display device 1 may be reduced.

In an embodiment, when the display device 1 is operated in the call mode, outputting of the touch signal ED may be stopped. For example, when the display device 1 is operated in the call mode, the touch signal ED may be maintained as a constant voltage (e.g., DC voltage). When the user makes a call by using the display device 1, outputting of the touch signal ED may be stopped, so that power consumption of the display device 1 may be reduced.

In an embodiment, the proximity sensor PS may be located in a sensing region SA. The proximity sensor PS may be located in a sensing region SA, so that the touch electrodes may not perform the proximity operation. Accordingly, an accuracy of a touch operation may be improved compared to the touch electrodes performing the proximity operation.

Additionally, the proximity sensor PS may be placed in the sensing region SA, so that the proximity sensor PS and electrodes for the touch sensing operation may not overlap. The proximity sensor PS and the electrodes for the touch sensing operation may not overlap, so that the reliability of the touch sensing operation may be improved.

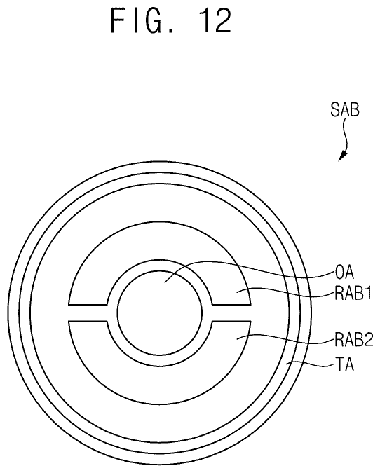

FIG. 12 is a diagram illustrating an example of a sensing region SA included in a display panel 100 of FIG. 2.

A sensing region SAB of FIG. 12 is substantially same as the sensing region SAA of FIG. 5, except that the sensing region SAB may include a first distance signal sensing region RAB1 and a second distance signal sensing region RAB2. Accordingly, the same reference numerals will be used for explaining the same elements in the drawings, and redundant descriptions about the same elements will be omitted.

The sensing region SASB may include the first distance signal sensing region RAB1 and the second distance signal sensing region RAB2. The first distance signal sensing region RAB1 may be located spaced apart from the second distance signal sensing region RAB2. The distance signal sensing electrode may be located in the first distance signal sensing region RAB1. The distance signal sensing electrode may be located in the second distance signal sensing region RAB2.

In an embodiment, the proximity sensor PS may be located in a sensing region SAB. The proximity sensor PS may be located in a sensing region SAB, so that the touch electrodes may not perform the proximity operation. Accordingly, an accuracy of a touch operation may be improved compared to the touch electrodes performing the proximity operation.

Additionally, the proximity sensor PS may be placed in the sensing region SAB, so that the proximity sensor PS and electrodes for the touch sensing operation may not overlap. The proximity sensor PS and the electrodes for the touch sensing operation may not overlap, so that the reliability of the touch sensing operation may be improved.

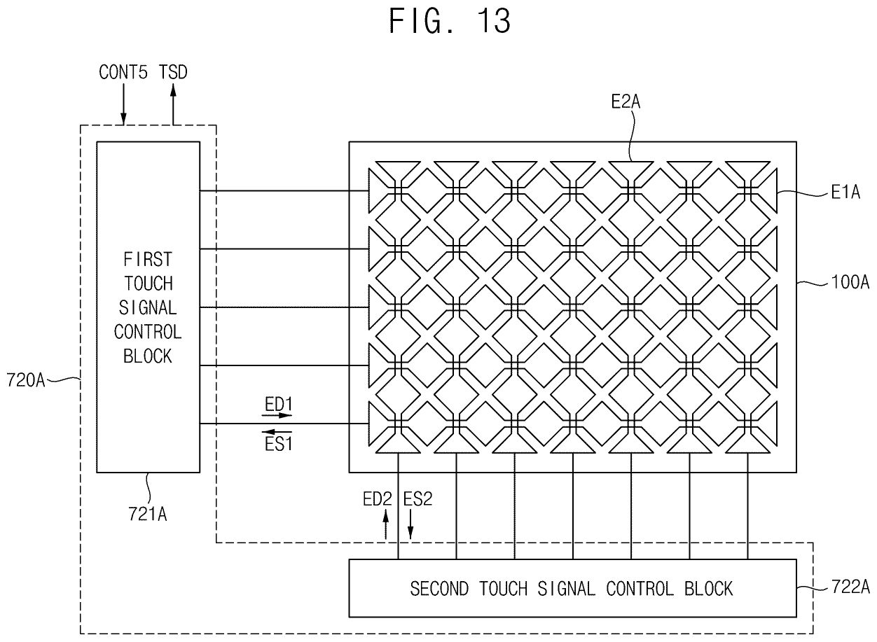

FIG. 13 is a block diagram illustrating a display panel 100 of FIG. 1 and a touch signal sensing block 720 of FIG. 3.

A display panel 100A of FIG. 13 is substantially same as the display panel 100 of FIG. 6, except that the plurality of first touch electrodes E1A and the plurality of second touch electrodes E2A included in a display panel 100A are located on substantially the same layer, and each of the plurality of first touch electrodes ElA and the plurality of second touch electrodes E2A may have a structure in which a plurality of continuous polygons having a diamond shape are connected to each other. Accordingly, the same reference numerals will be used for explaining the same elements in the drawings, and redundant descriptions about the same elements will be omitted.

Referring to FIG. 13, a touch signal sensing block 720A may include a first touch signal control block 721A and a second touch signal control block 722A. The plurality of first touch electrodes E1A and the plurality of second touch electrodes E2A included in a display panel 100A are located on substantially the same layer. Each of the plurality of first touch electrodes E1A and the plurality of second touch electrodes E2A may have a structure in which a plurality of continuous polygons having a diamond shape are connected to each other.

In an embodiment, the proximity sensor PS may be located in a sensing region SA. The proximity sensor PS may be located in a sensing region SA, so that the touch electrodes may not perform the proximity operation. Accordingly, an accuracy of a touch operation may be improved compared to the touch electrodes performing the proximity operation.

Additionally, the proximity sensor PS may be placed in the sensing region SA, so that the proximity sensor PS and electrodes for the touch sensing operation may not overlap. The proximity sensor PS and the electrodes for the touch sensing operation may not overlap, so that the reliability of the touch sensing operation may be improved.

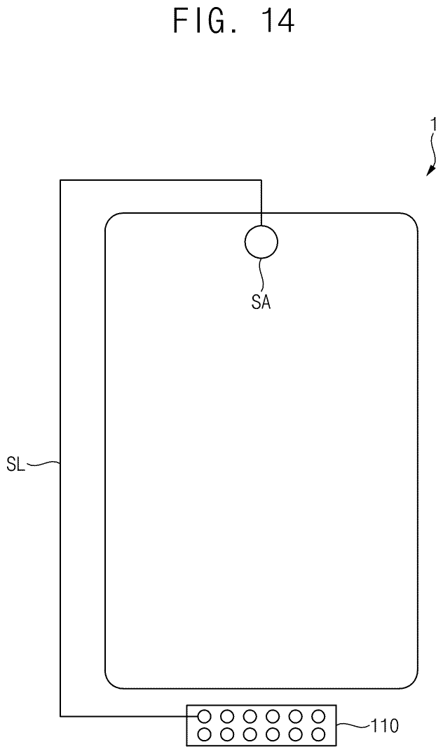

FIG. 14 is a diagram illustrating a display device 1 of FIG. 1.

Referring to FIG. 1 to FIG. 14, the display panel driver 110 may include a plurality of outputting pins. A first outputting pin may be connected to the sensing region SA through the distance sensing line SL. The first outputting pin may output the distance signal CD to the sensing region SA. Additionally, the first outputting pin may receive the distance sensing signal CS from the sensing region SA. A second outputting pin different from the first outputting pin may output the touch signal ED to the display panel 100.

In an embodiment, an outputting pin which outputs the touch signal ED and an outputting pin which outputs the distance signal CD may be different. Accordingly, a voltage range of the distance signal CD and a voltage range of the touch signal ED may be different. Additionally, a frequency of the distance signal CD and a frequency of the touch signal ED may be different. Accordingly, a power consumption of the display device 1 may be effectively controlled.

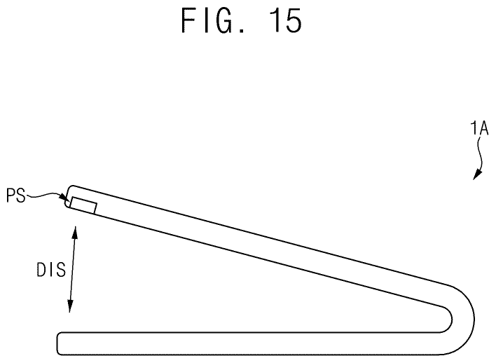

FIG. 15 is a diagram illustrating a display device 1 of FIG. 1.

Referring to FIG. 1 to FIG. 15, a display device 1A may be a foldable display device. When the display device 1A is the foldable display device, the display panel 100 may include a foldable region, a first non-folding region adjacent to the foldable region and a second non-folding region adjacent to the foldable region. The first non-folding region may include the sensing region SA. The proximity sensor PS may be located in the sensing region SA. When the capacitance variation which the proximity sensor PS detects is equal to or less than a reference capacitance variation, the display device 1A may be operated in the first mode MD1. For example, when the capacitance variation which the proximity sensor PS detects is equal to or less than the reference capacitance variation, the display panel 100 may display the image. In other words, when the capacitance variation which the proximity sensor PS detects is greater than the reference capacitance variation, the display panel 100 may stop displaying the image. Based on the capacitance variation which the proximity sensor PS detects, an angle between the first non-folding region and the second non-folding region may be determined. For example, when a distance between the proximity sensor PS and the second non-folding region is a reference distance DIS, the capacitance variation which the proximity sensor PS detects may be the reference capacitance variation. When the capacitance variation which the proximity sensor PS detects may be the reference capacitance variation, the angle between the first non-folding region and the second non-folding region may be a reference angle. When angle between the first non-folding region and the second non-folding region is greater than the reference angle, the display device 1A may be operated in the first mode MD1. When the angle between the first non-folding region and the second non-folding region is smaller than the reference angle, the display device 1A may be operated in the second mode MD2.

In an embodiment, the angle between the first non-folding region and the second non-folding region may be determined based on the proximity sensor PS. Accordingly, a driving reliability of the display device 1A may be improved.

In an embodiment, the proximity sensor PS may be located in a sensing region SA. The proximity sensor PS may be located in a sensing region SA, so that the touch electrodes may not perform the proximity operation. Accordingly, an accuracy of a touch operation may be improved compared to the touch electrodes performing the proximity operation.

Additionally, the proximity sensor PS may be placed in the sensing region SA, so that the proximity sensor PS and electrodes for the touch sensing operation may not overlap. The proximity sensor PS and the electrodes for the touch sensing operation may not overlap, so that the reliability of the touch sensing operation may be improved.

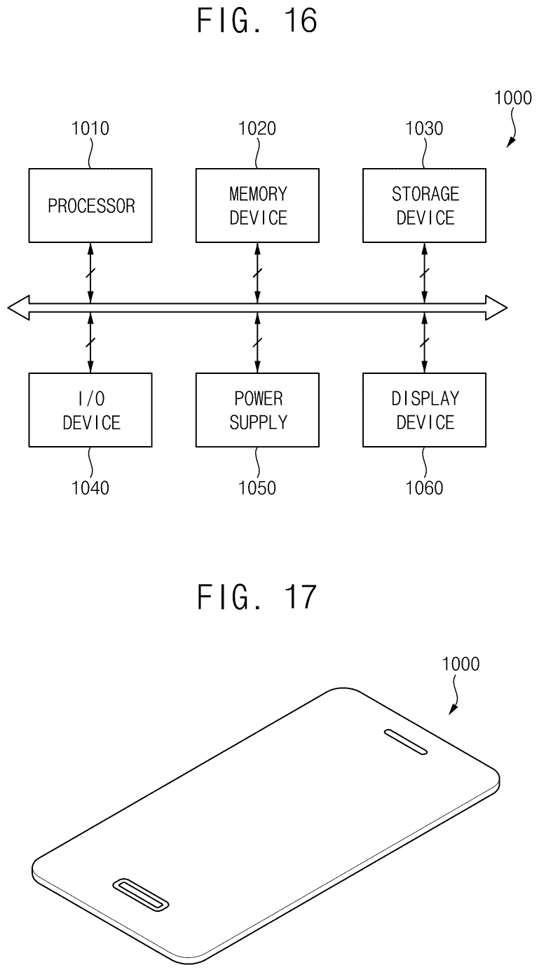

FIG. 16 is a block diagram illustrating an electronic device 1000 according to an embodiment of the present inventive concept. FIG. 17 is a diagram illustrating an example in which the electronic device of FIG. 16 is implemented as a smartphone.

Referring to FIG. 16, the electronic device 1000 may include a processor 1010, a memory device 1020, a storage device 1030, an input/output (I/O) device 1040, a power supply 1050, and a display device 1060. Here, the display device 1060 may be the display device 1 of FIG. 1. Here, the display device 1060 may be the display device 1A of FIG. 15. Additionally, the electronic device 1000 may further include a plurality of ports for communicating with a video card, a sound card, a memory card, a universal serial bus (USB) device, other electronic device, etc.

In an embodiment, as illustrated in FIG. 17, the electronic device 1000 may be implemented as a smartphone. However, the present inventive concept is not limited thereto. For example, the electronic device 1000 may be implemented as a cellular phone, a video phone, a smart pad, a smart watch, a tablet PC, a car navigation system, a computer monitor, a laptop, a head mounted display (HMD) device, or the like.

The processor 1010 may perform various computing functions or various tasks. The processor 1010 may be a micro-processor, a central processing unit (CPU), an application processor (AP), or the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data necessary for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, or the like. The I/O device 1040 may include an input device such as a keyboard, a keypad, a mouse, a touch-pad, a touch-screen, or the like, and an output device such as a printer, a speaker, or the like. The display device 1060 may be included in the I/O device 1040. The power supply 1050 may provide power necessary for operations of the electronic device 1000. The display device 1060 may be coupled to other components via the buses or other communication links.

Referring to FIG. 17, the electronic device of the present inventive concept may be implemented as a smartphone, but the present inventive concept is not limited thereto. The electronic device may be a television, a monitor, a laptop computer, or a tablet. Additionally, the electronic device may be implemented as a car navigation system.

The display device according to the embodiment may be applied to an electronic device included in a computer, a notebook, a mobile phone, a smart phone, a smart pad, a PMP, a PDA, an MP3 player, or the like.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

What is claimed is:

1. A display device comprising:
a display panel including a pixel circuit; and
a display panel driver configured to drive the display panel,
wherein the display panel includes:
a sensing region; and
a display region surrounding the sensing region,
wherein the sensing region includes a hole region including a hole which extends through the display panel and configured to transmit light, and a distance signal sensing region surrounding the hole region and including a distance signal sensing electrode, and
wherein a proximity sensor configured to detect proximity of an object based on a capacitance variation is located in the sensing region.

2. The display device of claim 1, wherein the display panel is configured to stop displaying an image when the proximity sensor detects that a distance between the object and the display panel is equal to or less than a second reference distance.

3. The display device of claim 2, wherein the display panel further includes a touch sensor configured to detect a touch,
wherein the display panel driver outputs a touch signal to the touch sensor, and
wherein the display panel driver stops outputting the touch signal when the proximity sensor detects that the distance between the object and the display panel is equal to or less than the second reference distance.

4. The display device of claim 3, wherein the display panel driver outputs a distance signal to the proximity sensor,
wherein the distance signal toggles between a first voltage and a second voltage lower than the first voltage,
wherein the touch signal toggles between a third voltage and a fourth voltage lower than the third voltage, and
wherein the first voltage is higher than the third voltage.

5. The display device of claim 4, wherein the distance signal has a first frequency, and the touch signal has a second frequency, and
wherein the first frequency is lower than the second frequency.

6. The display device of claim 3, wherein the display panel driver outputs a distance signal to the proximity sensor,
wherein the distance signal has a first frequency, and the touch signal has a second frequency, and
wherein the first frequency is different from the second frequency.

7. The display device of claim 6, wherein the first frequency is lower than the second frequency.

8. The display device of claim 1, wherein the display panel driver includes:
a gate driver configured to output a gate signal to the pixel circuit;
a data driver configured to apply a data voltage to the pixel circuit;
a touch driver configured to perform a touch sensing operation; and
a driving controller configured to control the gate driver, the data driver and the touch driver based on an input control signal,
wherein the display panel further includes a touch sensor configured to detect a touch, and
wherein the touch driver outputs a distance signal to the proximity sensor, and a touch signal different from the distance signal to the touch sensor.

9. The display device of claim 8, wherein the touch driver includes:
a distance signal sensing block configured to output the distance signal; and
a touch signal sensing block configured to output the touch signal, and
wherein the touch signal sensing block stops outputting the touch signal when the proximity sensor detects that a distance between the object and the display panel is equal to or less than the second reference distance.

10. The display device of claim 8, wherein the touch driver operates the display panel in a self-capacitance method.

11. The display device of claim 8, wherein the touch driver operates the display panel in a mutual capacitance sensing method.

12. The display device of claim 1, wherein the display panel includes a foldable region, a first non-folding region adjacent to the foldable region and a second non-folding region adjacent to the foldable region,
wherein the first non-folding region includes the sensing region, and
wherein when the capacitance variation is equal to or less than a reference capacitance variation, the display panel displays an image.

13. The display device of claim 12, wherein the capacitance variation is determined based on an angle between the first non-folding region and the second non-folding region.

14. The display device of claim 12, wherein when the capacitance variation is greater than the reference capacitance variation, the display panel stops displaying the image.

15. An electronic device comprising:
a display panel including a pixel circuit;
a display panel driver configured to drive the display panel based on input control signal; and
a processor configured to output the input control signal,
wherein the display panel includes:
a sensing region; and
a display region surrounding the sensing region,
wherein the sensing region includes a hole region including a hole which extends through the display panel and configured to transmit light, and a distance signal sensing region surrounding the hole region and including a distance signal sensing electrode, and
wherein a proximity sensor configured to detect proximity of an object based on a capacitance variation is located in the sensing region.

16. The electronic device of claim 15, wherein the display panel is configured to stop displaying an image when the proximity sensor detects that a distance between the object and the display panel is equal to or less than a second reference distance.

17. The electronic device of claim 16, wherein the display panel further includes a touch sensor configured to detect a touch,
wherein the display panel driver outputs a touch signal to the touch sensor, and
wherein the display panel driver stops outputting the touch signal when the proximity sensor detects that the distance between the object and the display panel is equal to or less than the second reference distance.

18. The electronic device of claim 17, wherein the display panel driver outputs a distance signal to the proximity sensor,
wherein the distance signal toggles between a first voltage and a second voltage lower than the first voltage,
wherein the touch signal toggles between a third voltage and a fourth voltage lower than the third voltage, and
wherein the first voltage is higher than the third voltage.

19. The electronic device of claim 18, wherein the distance signal has a first frequency, and the touch signal has a second frequency, and
wherein the first frequency is different from the second frequency.

20. The electronic device of claim 19, wherein the first frequency is lower than the second frequency.
